(19) United States
(12) Patent Application Publication
(10) Pub. No.: US 2016/0161018 A1
(43) Pub. Date: Jun. 9, 2016

(54) PILOT-OPERATED VALVE

(71) Applicant: PARKER-HANNIFIN CORPORATION, Cleveland, OH (US)

(72) Inventor: Robert William Zeiner, Torrington, CT (US)

(21) Appl. No.: 14/907,599

(22) PCT Filed: Aug. 28, 2014
(86) PCT No.: PCT/US2014/053189

§ 371 Date: Jan. 26, 2016

Related U.S. Application Data
(60) Provisional application No. 61/870,985, filed on Aug. 28, 2013.

(51) Int. Cl. F16K 31/40; F02M 63/00; F16K 39/02

(52) U.S. Cl. CPC F16K 31/408; F16K 39/024; F02M 63/0015

(57) ABSTRACT

Provided is a valve having a movable valve member with an orifice, a plunger movable to block/allow flow through the orifice, and a resilient biasing member for resiliently biasing the valve member away from the valve seat. When the plunger is moved to a position allowing flow, fluid flows through the orifice creating a pressure differential in the valve that in combination with the resilient biasing member moves the valve member to a position allowing flow through a main passageway of the valve. During a low or no flow condition, the valve member is held in the position allowing flow to prevent a drop in performance of a system utilizing the valve that would result if the valve member moved to a blocking position.

### RELATED APPLICATIONS

This application claims the benefit of U.S. Provisional Application No. 61/870,985 filed Aug. 28, 2013, which is hereby incorporated herein by reference.

### FIELD OF INVENTION

The present invention relates generally to flow control devices, and more particularly to pilot-operated valves for use with vehicles.

### BACKGROUND

Natural gas may be used as a vehicle engine fuel to provide environmental benefits over fuels such as diesel. The natural gas is stored in a highly compressed form, and the high pressure gas is fed through a regulator where the pressure is lowered and regulated and the feed of the fuel controlled before being fed to the engine. A valve may be provided between the fuel storage and the engine that is movable between an open position allowing flow from the fuel storage to the engine and a closed position prevent flow from the fuel storage to the engine.

### SUMMARY OF INVENTION

The present invention provides a valve having a movable valve member with an orifice, a plunger movable to block/allow flow through the orifice, and a resilient biasing member connecting the valve member to the plunger. When the plunger is moved to a position allowing flow, fluid flows through the orifice creating a pressure differential in the valve that in combination with the resilient biasing member moves the valve member to a position allowing flow through a main passageway of the valve. During a low or no flow condition, the valve member is held in the position allowing flow to prevent a drop in performance of a system utilizing the valve that would result if the valve member moved to a blocking position.

According to one aspect of the invention, a valve is provided that includes a valve body having an inlet port, an outlet port in selective fluid communication with the inlet port by a main passageway through the valve, and a valve seat surrounding the main passageway, a valve member mounted in the valve body for movement between first and second positions respectively blocking and permitting flow through the valve seat, the valve member having a piston portion that separates a control chamber upstream of the valve seat from a point downstream of the valve seat and a pilot orifice through the piston portion for bleeding off pressure from the control chamber to the point downstream of the valve seat, a plunger movable between a first position blocking flow through the pilot orifice and a second position allowing flow through the pilot orifice, and a resilient biasing member connecting the valve member to the plunger.

The resilient biasing member may be a spring having one end fixed to the plunger and an opposite end fixed to the valve member such that the valve member is hung from the plunger.

When the plunger is moved to the second position, fluid flows through the pilot orifice creating a pressure differential between the control chamber and the point downstream of the valve seat that in combination with the resilient biasing member moves the valve member to the second position allowing flow through the main passageway from the inlet port through the valve seat to the outlet port.

The valve may further include a bleed orifice in communication with the inlet and the control chamber for allowing pressure from the inlet to build up in the control chamber for urging the valve member in the first position when the plunger is in the first position.

The pilot orifice may have a cross-sectional area that is greater than a cross-sectional area of the bleed orifice.

According to another aspect of the invention, a valve is provided that includes a valve body having an inlet and an outlet in selective fluid communication with the inlet by a main passageway through the valve, and a valve seat disposed along the main passageway, a valve member mounted in the valve body for movement between first and second positions respectively blocking and permitting flow through the valve seat, the valve member having a piston portion that separates a control chamber upstream of the valve seat from a point downstream of the valve seat, a pilot orifice through the piston portion for bleeding off pressure from the control chamber to the point downstream of the valve seat, and a bleed orifice in communication with the inlet and the control chamber, a resilient member, and a plunger assembly coupled to the valve member by the resilient member and being movable between a first position blocking flow through the pilot orifice and a second position allowing flow through the pilot orifice.

According to yet another aspect of the invention a valve is provided that includes a body having an inlet, an outlet, a passageway through the valve from the inlet to the outlet, and a valve seat surrounding the passageway, a piston separating the valve body into a plunger-side cavity and a main cavity, the piston having a bleed passage that provides fluid communication between the inlet and the plunger-side cavity and a pilot passage that provides fluid communication between the plunger-side cavity and the main cavity, wherein the pilot passage has a cross-sectional area that is greater than a cross-sectional area of the bleed passage, and a plunger coupled to the piston by a resilient member, the plunger being axially movable by energizing a coil to open/close the pilot passage, wherein at high inlet pressures the valve is opened by energizing the coil to open the pilot passage to exhaust fluid from the plunger-side cavity to the main cavity creating a pressure differential between the plunger-side cavity and main cavity that in combination with the resilient member moves the piston away from the valve seat, and at low inlet pressures the valve held open by the resilient member.

According to a further aspect of the invention, a method is provided for opening and closing a valve to allow fluid flow from a fluid source through the valve, the valve including a valve body having a valve seat, a coil assembly, a plunger movable by the coil assembly, a valve member mounted in the valve body for movement between first and second positions respectively blocking and permitting flow through the valve seat, and a resilient member configured to hold the valve member away from the valve seat. The method includes energizing the coil assembly to move the plunger from a first position blocking flow through a pilot orifice in the valve member to a second position allowing flow through the pilot orifice, and directing fluid through the pilot orifice creating a pressure differential between a chamber above the valve member and a point downstream of the valve seat that in combination with the resilient biasing member moves the valve member to the second position allowing flow through the valve seat.

The foregoing and other features of the invention are hereinafter described in greater detail with reference to the accompanying drawings.

### BRIEF DESCRIPTION OF THE DRAWINGS

FIG. 1 is a perspective view of an exemplary pilot-operated valve according to the invention.

FIG. 2 is another perspective view of the pilot-operated valve.

FIG. 3 is a bottom view of the pilot-operated valve.

FIG. 4 is a top view of the pilot-operated valve.

FIG. 5 is a left side view of the pilot-operated valve.

FIG. 6 is a right side view of the pilot-operated valve.

FIG. 7 is an exploded view of the pilot-operated valve.

FIG. 8 is a cross-sectional view taken about line 8-8 in FIG. 6 showing the pilot-operated valve in a de-energized position.

FIG. 9 is a cross-sectional view of the pilot-operated valve in an energized position.

FIG. 10 is another cross-sectional view of the pilot-operated valve in the de-energized position.

FIG. 11 is a cross-sectional view of the pilot-operated valve after a coil has been energized.

FIG. 12 is a cross-sectional view of the pilot-operated valve in the energized position after the coil has been energized and a valve member moved away from a valve seat.

FIG. 13 is a cross-sectional view of the pilot-operated valve after a coil has been de-energized and before the valve member has moved towards the valve seat.

FIG. 14 is another cross-sectional view of the pilot-operated valve after a coil has been de-energized and before the valve member has moved towards the valve seat.

### DETAILED DESCRIPTION

The principles of this present invention have particular application to pilot-operated valves that serve as a safety shutoff valve between a compressed natural gas supply and an engine of a vehicle serving as a redundancy for shutting off the engine, and thus will be described below chiefly in this context. It will of course be appreciated, and also understood, that principles of this invention may be applicable to other systems using a shutoff valve.

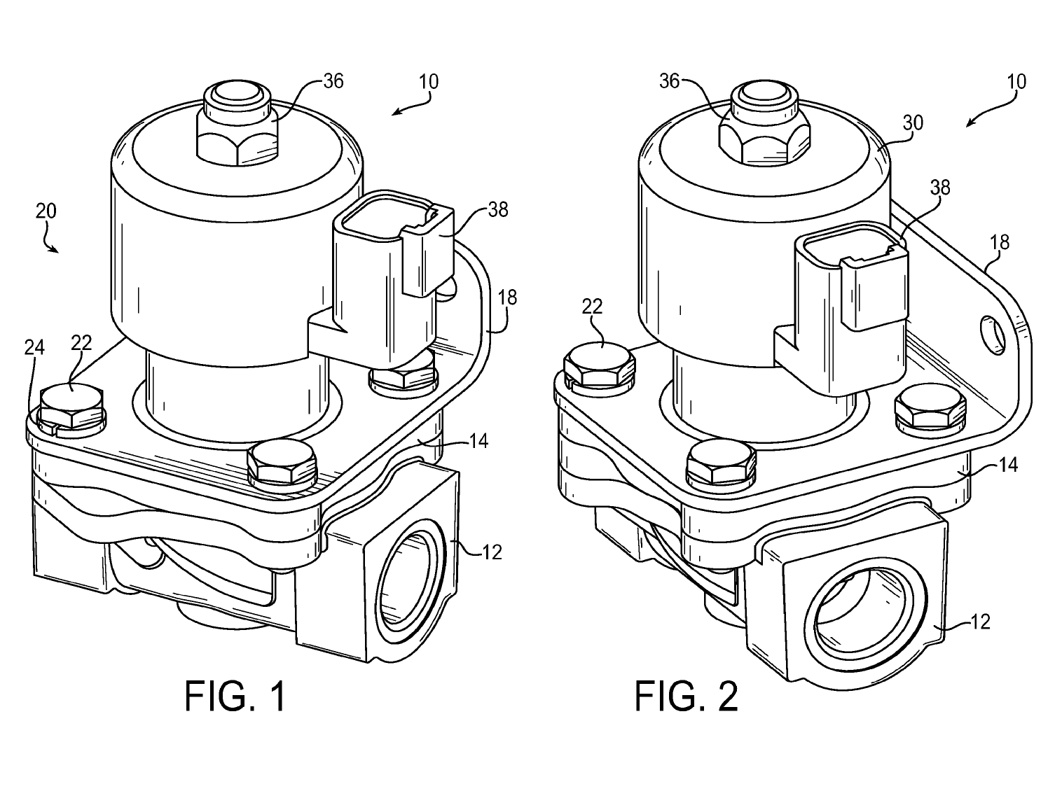

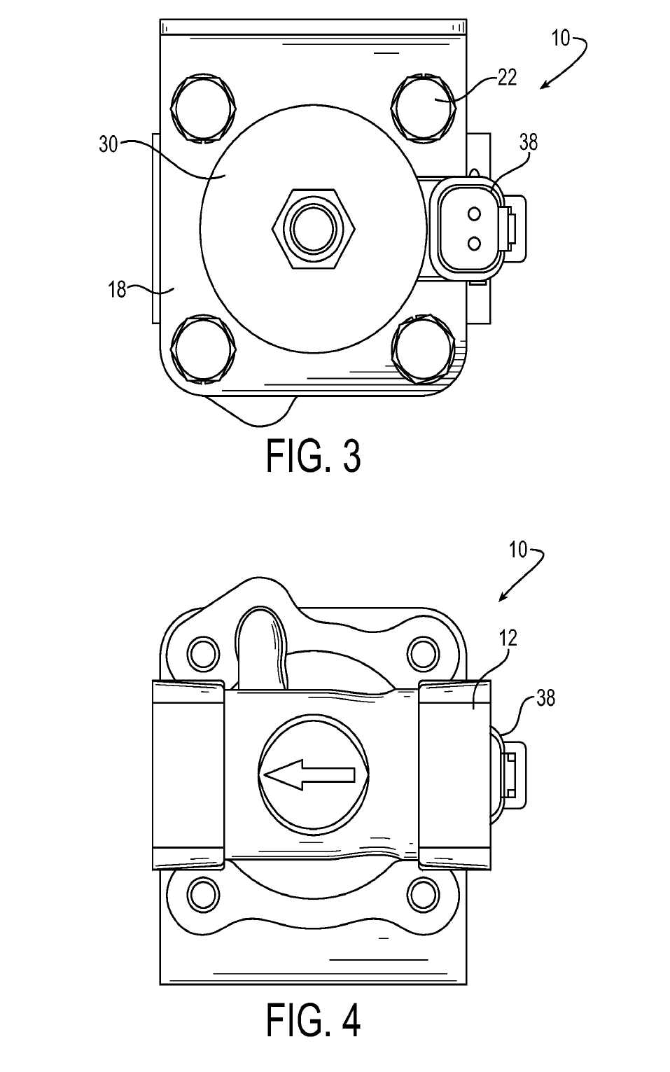

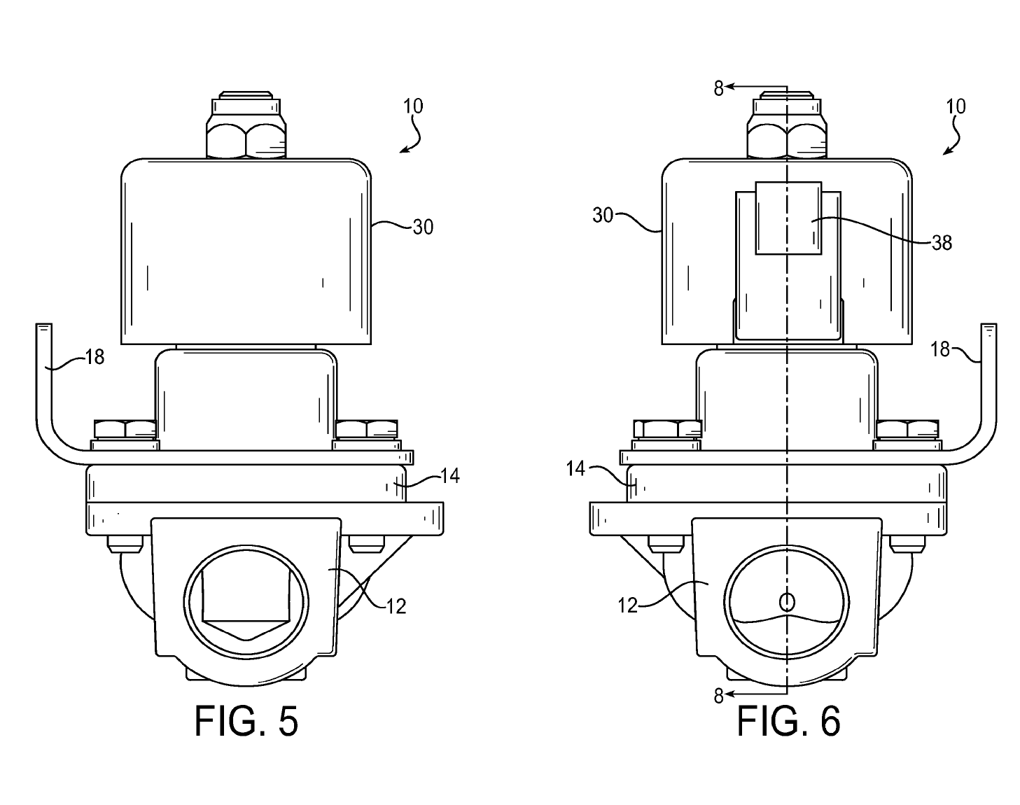

Referring to the drawings, and initially to FIGS. 1-7, an exemplary pilot-operated valve is illustrated generally at reference numeral 10. The valve includes a body, which includes valve body 12 and cover 14 sealed to the body 12 by a suitable seal 16, such as an o-ring, a bracket 18 for mounting the valve 10 to a vehicle, and a solenoid assembly 20 coupled to the cover 14. The valve body 12, cover 14 and bracket 18 are coupled together by suitable fasteners 22, such as bolts, extending through openings in the valve body 12, cover 14, and bracket 18, and washers 24, such as lock washers, are provided between the fasteners 22 and bracket 18.

The solenoid assembly 20 is coupled to the cover 14 in any suitable manner, such as by a threaded connection, and is sealed to the cover 14 by a suitable seal 26, such as an o-ring. The solenoid assembly 20 includes a coil assembly 30, a plunger 32 that is axially movable under the magnetic influence of the coil assembly 30, a sleeve 34 in which the plunger is axially moved, a nut 36 coupled to sleeve 34 to secure the sleeve relative to the coil assembly 30, and a coupling device 38 configured to be coupled to a control device, such as an engine controller that energizes/de-energizes the assembly 30. The sleeve 34 may be a laser welded sleeve having threaded ends that are magnetic stainless steel, for example, and a central tube that is a non-magnetic series stainless steel, for example, which can create a magnetic circuit to drive the attraction between the stop and the plunger 80 when energized.

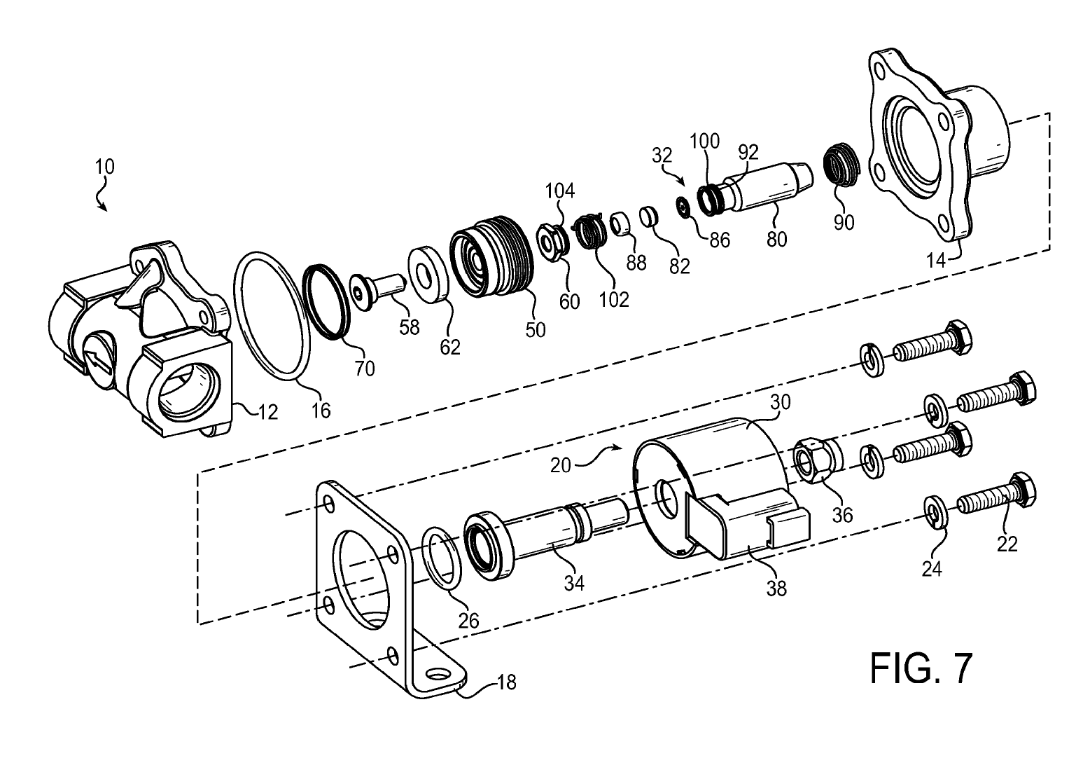

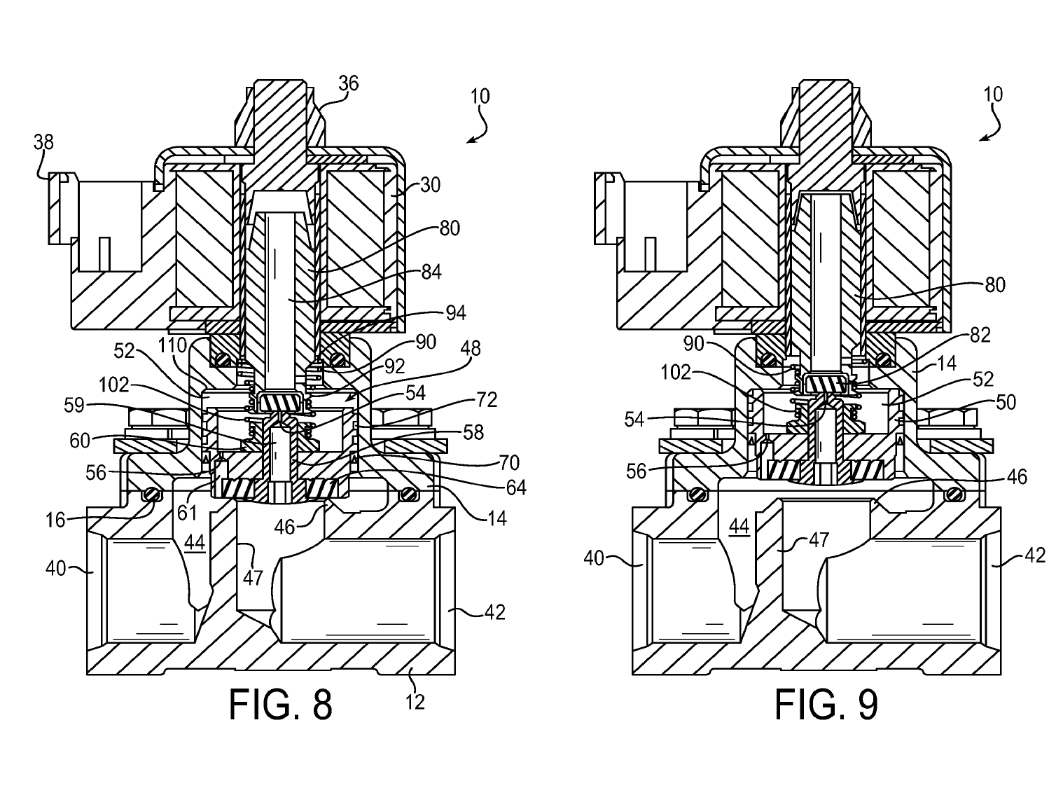

Turning now to FIG. 7 in addition to FIG. 8, the valve body 12 has an inlet port 40, an outlet port 42 in selective fluid communication with the inlet port 40 by a main passageway 44 through the valve, and a valve seat 46 surrounding the main passageway 44. The valve body 12 includes a wall 47, an upper portion of which forms the valve seat 46, which directs the flow from the inlet port 40 through the main passageway 44 upward towards the valve seat 46. Fluid, such as compressed natural gas, can then flow through the valve seat 46 along the main passageway 44 to the outlet port 42 when a valve member 48 is moved away from the valve seat 46. Although described as being part of the valve body 12, it will be appreciated that the valve seat 46 may be separate from the valve body 12.

The valve member 48 is mounted in the body between the valve body 12 and cover 14 for movement between a first position blocking flow through the valve seat 46 and a second position permitting flow through the valve seat 46. The valve member 48 has a piston portion 50 that separates a control chamber 52 upstream of the valve seat 46 from a point downstream of the valve seat 46, a pilot orifice 54 through the piston portion 50, and a bleed orifice 56 in communication with the inlet 40 and the control chamber 52. The bleed orifice 56 allows pressure from the inlet 40 to build up in the control chamber 52 for urging the valve member 48 in the closed position when the coil assembly 30 is de-energized. Although shown as extending through the piston portion 50, it will be appreciated that the bleed orifice 56 may be formed in the valve body 12 or cover 14.

The pilot orifice 54, which is provided for bleeding off pressure from the control chamber 52 to the point downstream of the valve seat 46, has a cross-sectional area that is greater than a cross-sectional area of the bleed orifice 56. The pilot orifice 54 and a pilot passage 59 are shown extending through an orifice member 58 that extends through the piston portion 50 and is coupled to the piston portion by a coupling device 60, such as a nut threadably engaged to an end of the orifice member 58. Sandwiched between the orifice member 58 and the piston portion 50 is a suitable seal 62 that seals the valve member 48 to the valve seat 46 in the closed position. The pilot orifice 54 and pilot passage 59 extend through the orifice member 58 and the pilot passage 59 opens to a bottom of the piston portion 50 interiorly of the seal 62, and the bleed orifice 56 and passage 61 open radially outwardly of the seal 62. The seal 62 may protrude into the bleed passage 61 to serve as a debris trap to shield debris from entering the bleed orifice 56. The piston portion 50 includes one or more ribs 64 and the orifice member 58 includes one or more ribs (not shown) that engage the seal 62 creating a high stress area for high pressure sealing.

The valve 10 additionally includes a seal member 70 surrounding the piston portion 50 for sealing the piston portion 50 to the cover 14, for providing frictional damping, and for serving as a bearing between the piston portion 50 and cover 14 as the piston portion is moved axially relative to the cover 14. The seal member 70 has a spring portion that urges the seal member 70 radially outward to accommodate for wear and to cause the seal member 70 to serve as a scraper to clean a piston bore of the cover 14. The piston portion 50 includes one or more debris glands 72 on a radially outer wall of the piston portion that serve to lighten the piston portion 50 and collect the debris from the scraper generated by piston wear or debris/contaminants which made it past the bleed orifice 56.

Referring now to the plunger 32 in detail, the plunger is movable between a first position blocking flow through the pilot orifice 54 when the coil assembly 30 is de-energized and a second position allowing flow through the pilot orifice 54 when the coil assembly 30 is energized. The plunger 32 includes a plunger member 80 movable under the magnetic influence of the coil assembly 30, a seal 82 disposed in a bore 84 of the plunger member 80 for sealing the pilot orifice 54 when the plunger is in the first position, a washer 86 abutted by the seal 82 and seated against a ledge in the bore 84, and a retainer 88 secured to the plunger member 80 in the bore 84 in any suitable manner to retain the seal 82 within the bore 84.

The plunger member 80 is biased in first position by a resilient member 90, such as a spring, that has one end seated on a ledge 92 on an outer portion of the plunger member 80 and an opposite end seated on a ledge 94 of the sleeve 34. The plunger member 80 has a taper at an upper portion thereof, for example a fifteen degree taper, which allows for a longer magnetic stroke to improve magnetic efficiency.

The plunger member 80 also includes a groove 100 formed on the outer portion thereof for receiving a resilient biasing member 102, such as a spring, such as a tension spring, that is configured to hold the valve member 48 away from the valve seat 46 and couples the plunger member 80 to the valve member 48. The resilient biasing member 102 is fixed at one end to the plunger member 80 in the groove and has an opposite end fixed to the valve member 48, and as shown fixed to the nut 60 in an outer groove 104 thereof, such that the valve member 48 is hung from the plunger member 80, for example with a light attractive force or bias. As is discussed in detail below, when the plunger member 80 is in the second position where the seal 82 is unseated from the pilot orifice 54, when there is low or no flow through the main passageway 44, the resilient biasing member 102 resiliently biases the valve member 48 in the second position away from the valve seat 46. In this way, during the low or no flow condition, such as when a vehicle operator has let off of the throttle of the vehicle, the valve member 48 will be held in the second position to prevent a drop in performance of the vehicle that would otherwise occur if the valve member 48 was allowed to move to the first position during the low or no flow condition.

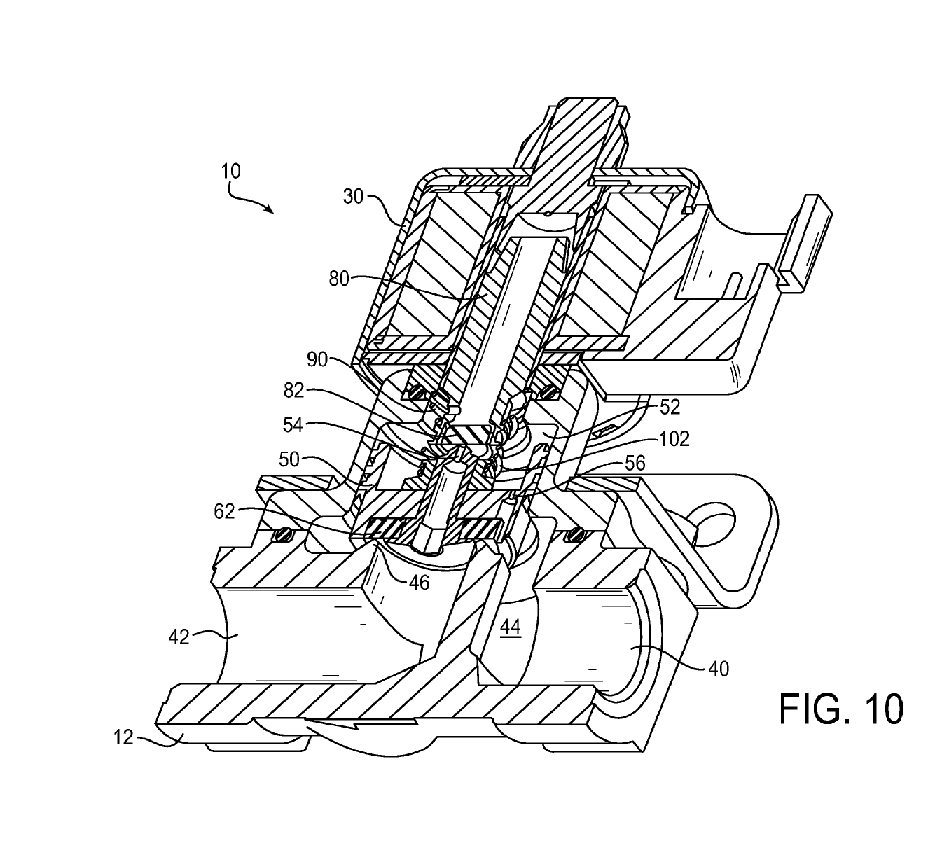

As shown in FIG. 10, when the valve 10 is installed in a vehicle between the fluid source and the engine and when the vehicle is off, the coil assembly 30 is de-energized and the resilient member 90 biases the plunger member 80 in the first position blocking flow through the pilot orifice 54 and holding the valve member 48 in the first position blocking flow through the valve seat 46. Fluid flows from the fluid source to the inlet port 44 and through the main passageway 44, where the fluid flows through the bleed orifice 56 and fills the control chamber 52. The piston portion 50 has a larger diameter than the valve seat 46 and the pressure at the point downstream of the valve seat 46 is lower than the inlet pressure, and thus the pressure of the fluid in the control chamber 52 acts on the piston portion 50 to hold the valve member 48 in the first position blocking flow through the valve seat 46.

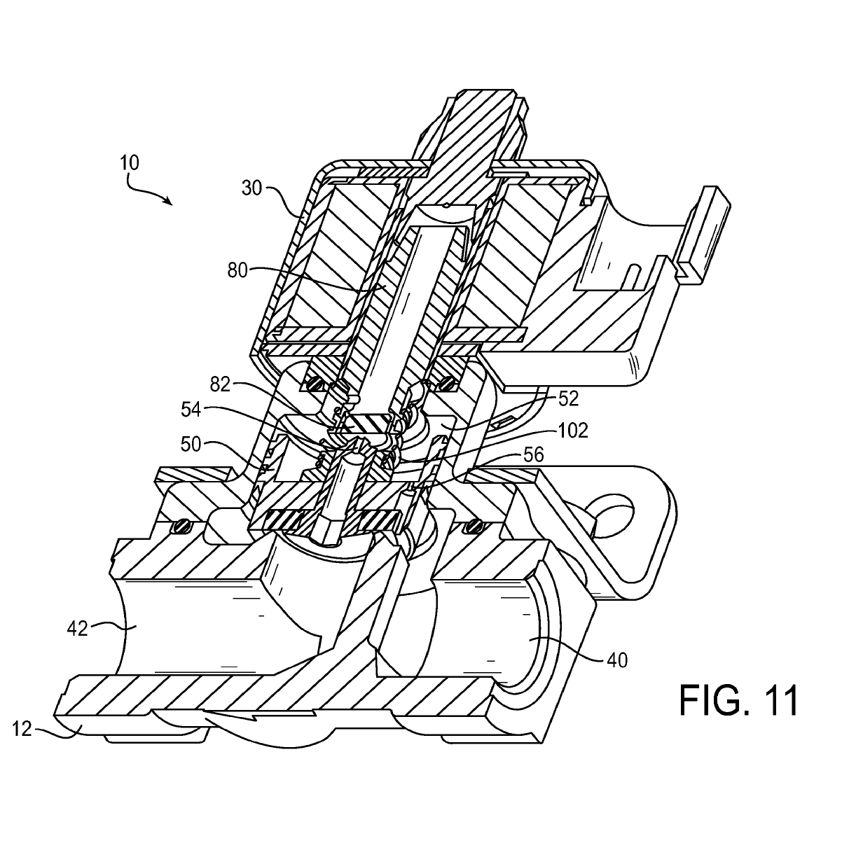

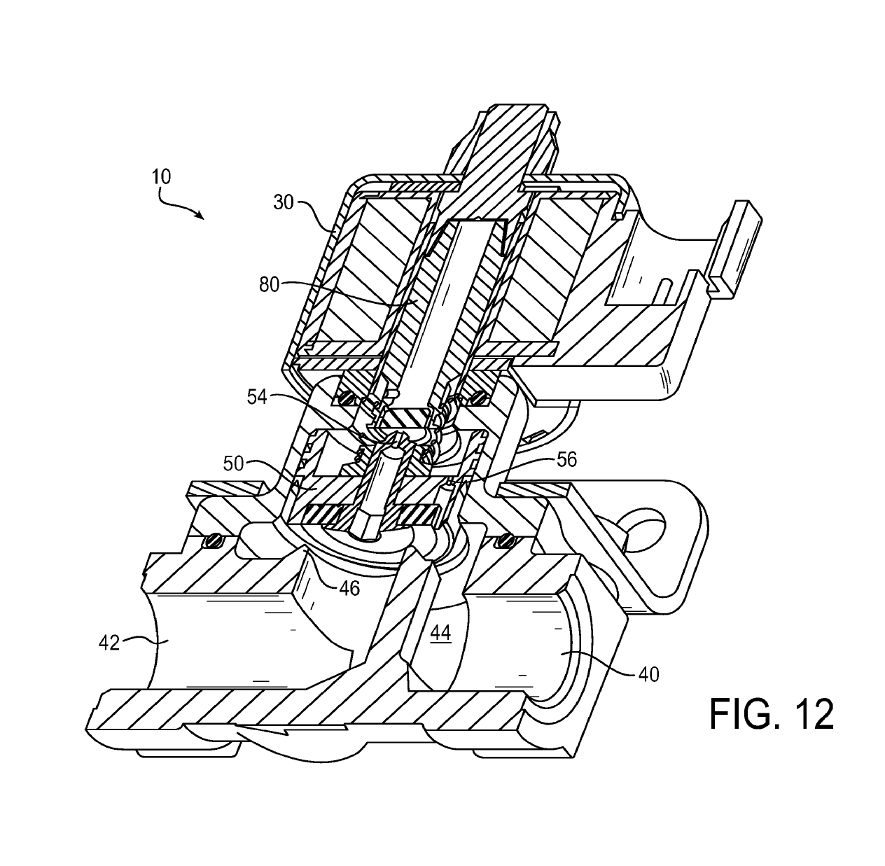

As shown in FIG. 11, when the vehicle is started up, for example, a controller in the vehicle may energize the coil assembly 30, which causes the plunger member 80 to move axially upward unseating the seal 82 from the pilot orifice 54 and moving the plunger member 80 to the second position allowing flow through the pilot orifice 54. The fluid in the control chamber 52 then flows through the pilot orifice 54 to the area downstream of the valve seat 46. The pilot orifice 54 has a cross-sectional area that is greater than a cross-sectional area of the bleed orifice 56, for example a ratio of three to one, and thus the fluid flows to the point downstream of the valve seat 46 faster than the fluid fills the control chamber 52. As shown in FIG. 12, the fluid flowing through the pilot orifice 54 thereby creates a pressure differential between the control chamber 52 and the point downstream of the valve seat 46 that in combination with the resilient biasing member 102 moves the valve member 48 from the first position to the second position where the piston portion 50 contacts a shoulder 110 in the cover 14 that serves as a stop. As the piston portion 50 moves from the first position to the second position, fluid flows through the main passageway 44 from the inlet port 40 through the valve seat 46 to the outlet port 42. While the coil assembly 30 is energized, the seal 82 of the plunger remains unseated from the pilot orifice 54 so that a pressure force holds the piston portion 50 against the stop 110.

If the inlet pressure is low such that the pressure differential is not sufficient to assist in moving the valve member 48 to the second position, the valve member 48 is pulled upward towards the plunger member 80 to the second position by the resilient biasing member 102. While the coil assembly 30 is energized, the seal 82 remains unseated from the pilot orifice 54 due to the resilient biasing member holding the piston portion 50 in the hung position.

If during operation of the vehicle the operator has let off of the throttle closing the vehicle injectors, the fluid stops flowing from the fluid source through the valve 10 to the engine. When this occurs, the vehicle will be in a low flow or no flow condition and the pressure differential between the control chamber 52 and the point downstream of the valve seat 46 will move towards zero. As the pressure differential moves towards zero, there is no pressure force from the fluid holding the piston portion 50 against the stop 110. To prevent the valve member 48 from seating against the valve seat 46, which would create a drop in performance during the low flow or no flow condition, the resilient biasing member 102 holds the valve member 48 in the second position away from the valve seat 46. In this way, when the operator presses the throttle, fluid can flow through the main passageway 44 from the inlet port 40 through the valve seat 46 to the outlet port 42 with a lag in performance.

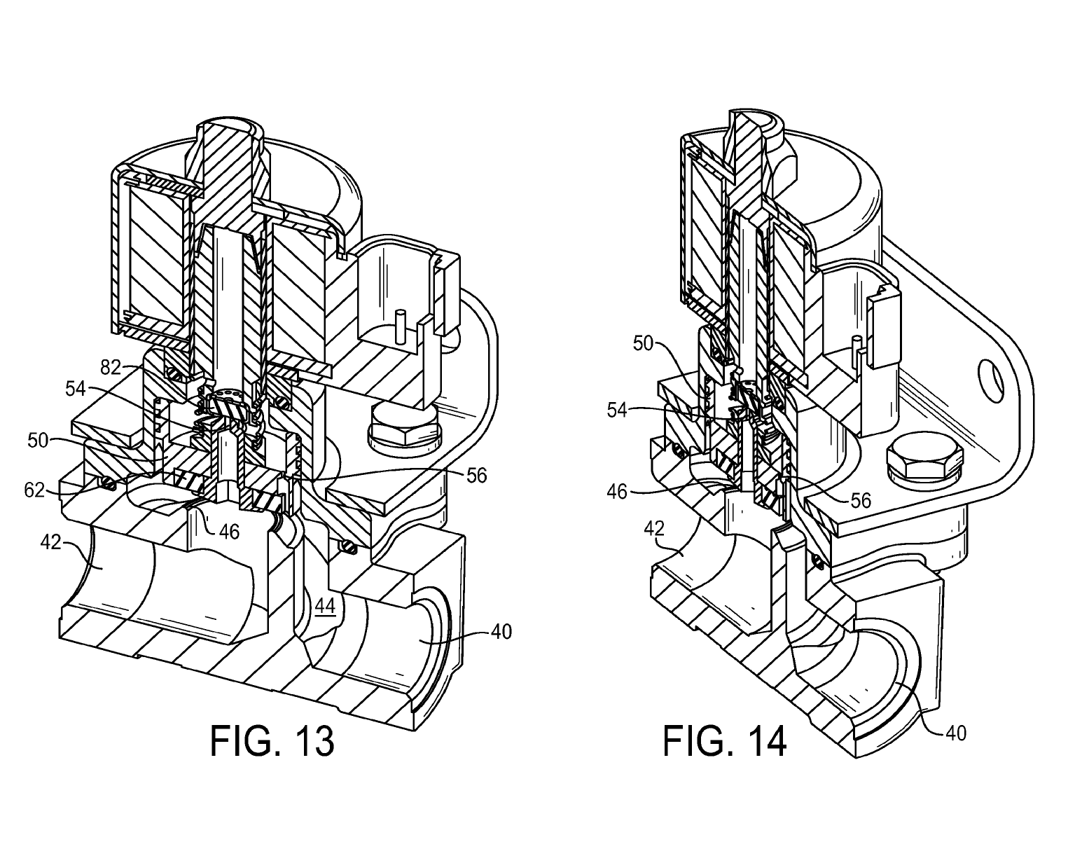

As shown in FIGS. 13 and 14, when the coil assembly 30 is de-energized, for example when the vehicle is turned off, the magnetic influence of the coil assembly 30 no longer holds the plunger member 80 in the second position and the plunger member 80 moves axially downward seating the seal 82 against the pilot orifice 54. Fluid continues to flow through the main passageway 44 from the inlet port 40 through the valve seat 46 to the outlet port 42 while at the same time fluid flowing through the bleed orifice 56 begins to build in the control chamber 52. As the pressure in the control chamber 52 increases, the valve member 48 moves downward towards the first position until the valve member 48 is seated on the valve seat 46 and sealed to the valve seat by the seal 62 as shown in FIG. 10. At this point, the piston portion 50 has a larger diameter than the valve seat 46 and the pressure at the point downstream of the valve seat 46 is lower than the inlet pressure, and thus the pressure of the fluid in the control chamber 52 acts on the piston portion 50 to hold the valve member 48 in the first position blocking flow through the valve seat 46.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A valve including:
a valve body having an inlet port, an outlet port in selective fluid communication with the inlet port by a main passageway through the valve, and a valve seat surrounding the main passageway;
a valve member mounted in the valve body for movement between first and second positions respectively blocking and permitting flow through the valve seat, the valve member having a piston portion that separates a control chamber upstream of the valve seat from a point downstream of the valve seat and a pilot orifice through the piston portion for bleeding off pressure from the control chamber to the point downstream of the valve seat;
a plunger movable between a first position blocking flow through the pilot orifice and a second position allowing flow through the pilot orifice; and
a resilient biasing member connecting the valve member to the plunger, wherein the resilient biasing member holds the valve member in the second position away from the valve seat when the plunger is in the second position.

2. The valve according to claim 1, wherein the resilient biasing member is a spring having one end fixed to the plunger and an opposite end fixed to the valve member such that the valve member is hung from the plunger.

3. The valve according to claim 1, wherein when the plunger is moved to the second position, fluid flows through the pilot orifice creating a pressure differential between the control chamber and the point downstream of the valve seat that in combination with the resilient biasing member moves the valve member to the second position allowing flow through the main passageway from the inlet port through the valve seat to the outlet port.

4. The valve according to claim 1, further including a bleed orifice in communication with the inlet and the control chamber for allowing pressure from the inlet to build up in the control chamber for urging the valve member in the first position when the plunger is in the first position.

5. The valve according to claim 4, wherein the pilot orifice has a cross-sectional area that is greater than a cross-sectional area of the bleed orifice.

6. The valve according to claim 4, wherein the pilot orifice and a pilot passage extend through the valve member and the pilot passage opens to a bottom of the piston portion interiorly of a seal that seals the valve member to the valve seat.

7. The valve according to claim 6, wherein the bleed orifice opens radially outwardly of the seal.

8. (canceled)

9. The valve according to claim 1, further including a coil that when energizes moves the plunger to the second position.

10. The valve according to claim 1, further including a resilient member that biases the plunger in the first position, wherein the plunger has a first portion serving as a seat for an end of the resilient member and a second portion serving as a seat for the resilient biasing member.

11. (canceled)

12. The valve according to claim 1, further including a seal member surrounding the piston portion for sealing the piston portion to the valve body and for serving as a bearing between the piston portion and valve body, wherein the seal member has a spring portion that urges the seal radially outward.

13. (canceled)

14. The valve according to claim 1, wherein the piston portion includes a debris gland on a radially outer portion thereof.

15. The valve according to claim 1, further including a seal that seals the valve member to the valve seat, wherein a bottom of the piston portion abuts the seal and includes one or more ribs that engage the seal creating a high stress area.

16-17. (canceled)

18. A valve including:
a valve body having an inlet and an outlet in selective fluid communication with the inlet by a main passageway through the valve, and a valve seat disposed along the main passageway;
a valve member mounted in the valve body for movement between first and second positions respectively blocking and permitting flow through the valve seat, the valve member having a piston portion that separates a control chamber upstream of the valve seat from a point downstream of the valve seat, and a pilot orifice through the piston portion for bleeding off pressure from the control chamber to the point downstream of the valve seat;
a plunger coupled to the piston by a resilient biasing member, the plunger being axially movable by energizing a coil between a first position blocking flow through the pilot orifice and a second position allowing flow through the pilot orifice;
a resilient member biasing the plunger in the first position; and
a resilient biasing member coupled between the plunger and valve member and being configured to hold the valve member away from the valve seat when the plunger is in the second position.

19. The valve according to claim 18, wherein when the plunger is moved to the second position, fluid flows through the pilot orifice creating a pressure differential between the control chamber and the point downstream of the valve seat that in combination with the resilient biasing member moves the valve member to the second position allowing flow through the main passageway from the inlet port through the valve seat to the outlet port.

20. (canceled)

21. The valve according to claim 18, wherein the resilient biasing member has one end fixed to the plunger and an opposite end fixed to the valve member such that the valve member is hung from the plunger.

22. The valve according to claim 18, wherein the pilot orifice has a cross-sectional area that is greater than a cross-sectional area of a bleed orifice providing communication between the net and the control chamber.

23. The valve according to claim 18, wherein the pilot orifice and a pilot passage extend through the valve member and the pilot passage opens to a bottom of the piston portion interiorly of a seal that seals the valve member to the valve seat.

24. The valve according to claim 23, wherein the bleed orifice opens radially outwardly of the seal.

25. The valve according to claim 18, wherein when the plunger is in the second position, the resilient biasing member holds the valve member in the second position away from the valve seat.

26-27. (canceled)

28. A method for opening and closing a valve to allow fluid flow from a fluid source through the valve, the valve including a valve body having a valve seat, a coil assembly, a plunger movable by the coil assembly, a valve member mounted in the valve body for movement between first and second positions respectively blocking and permitting flow through the valve seat, and a resilient member configured to hold the valve member away from the valve seat, the method including:
energizing the coil assembly to move the plunger from a first position blocking flow through a pilot orifice in the valve member to a second position allowing flow through the pilot orifice;
directing fluid through the pilot orifice creating a pressure differential between a chamber above the valve member and a point downstream of the valve seat that in combination with the resilient biasing member moves the valve member to the second position allowing flow through the valve seat; and
when the plunger is in the second position, the resilient biasing member holding the valve member in the second position away from the valve seat.

29. (canceled)
